(19) United States
(12) Patent Application Publication
(10) Pub. No.: US 2017/0027016 A1
(43) Pub. Date: Jan. 26, 2017

(54) COMMUNICATION DEVICE, WIRELESS COMMUNICATION DEVICE, AND COMMUNICATION METHOD

(71) Applicant: FUJITSU LIMITED, Kawasaki-shi (JP)

(72) Inventor: Junichi Suga, Ota (JP)

(73) Assignee: FUJITSU LIMITED, Kawasaki-shi (JP)

(21) Appl. No.: 15/216,350

(22) Filed: Jul. 21, 2016

(30) Foreign Application Priority Data
Jul. 24, 2015 (JP) 2015-147271

(51) Int. Cl. H04W 76/02; H04L 29/12; H04L 29/06

(52) U.S. Cl. CPC H04W 76/026; H04L 69/16; H04L 61/2007

(57) ABSTRACT

A communication device including: a processor configured to: perform a data communication in a connection established between the communication device and another communication device based on a first communication protocol, and when a first connection based on the first communication protocol has been established between the communication device and another specified communication device via a first wireless communication network based on a first radio access technology and when a second connection based on the first communication protocol is started between the communication device and the other specified communication device via a second wireless communication network based on a second radio access technology, start the second connection without closing the first connection, wherein a determination whether to close the first connection is made based on an index value relating a second data transfer rate of the second connection in the first layer of the first communication protocol.

### CROSS-REFERENCE TO RELATED APPLICATION

This application is based upon and claims the benefit of priority of the prior Japanese Patent Application No. 2015-147271, filed on Jul. 24, 2015, the entire contents of which are incorporated herein by reference.

### FIELD

The embodiments discussed herein are related to a communication device, a wireless communication device, and a communication method.

### BACKGROUND

Nowadays, as is well known, a wireless terminal capable of utilizing multiple wireless communication systems is widely spread in general. Here, the multiple wireless communication systems may be alternatively referred to as multiple wireless communication methods or radio access technologies (RATs). The multiple wireless communication systems are, for instance, a cellular communication system such as Long Term Evolution (LTE) and a wireless local area network (LAN) communication system such as wireless fidelity (Wi-Fi (registered trademark)). Also, the wireless terminal herein refers to any terminal device having wireless communication functions, and includes a smart phone, a mobile phone, a tablet terminal, and a personal computer (PC).

As an example, a wireless terminal capable of utilizing multiple wireless communication systems enables adaptive selection of a wireless communication system according to time and circumstances by using wireless communication based on the multiple wireless communication systems in a switching manner. As another example, the wireless terminal is allowed to perform large-capacity wireless communication by using wireless communications in combination based on multiple wireless communication systems. In this manner, the wireless terminal provides various advantages which are not available from a wireless terminal based on a single wireless communication system only.

On the other hand, when a wireless terminal accesses to a server on the Internet (such as web server) for instance, the wireless terminal performs data communication with the server based on the transmission control protocol/internet protocol (TCP/IP) which is a standard protocol on the Internet. Here, IP is a protocol of a network layer corresponding to the third layer in the open system interconnection (OSI) reference model, and serves for data relay between devices. On the other hand, TCP is a protocol of a transport layer corresponding to the fourth layer in the OSI reference model, and serves for (end-to-end) communication management between devices. The communication management served by TCP includes various types of control such as retransmission control and congestion control for ensuring the reliability of communication. Using TCP/IP allows the wireless terminal to perform data communication, for instance, with a server on the Internet with a certain level of reliability.

Related techniques are disclosed in, for example, Japanese Laid-open Patent Publication Nos. 2010-213013, 2008-236079, and 2012-222777.

Related techniques are also disclosed in, for example, A. Ford, et al., “TCP Extensions for Multipath Operation with Multiple Addresses”, IETF RFC 6824, January 2013 and Christoph Paasch, et al., “Exploring mobile/WiFi handover with multipath TCP”, Proceedings of the 2012 ACM SIGCOMM workshop on Cellular networks: operations, challenges, and future design, August 2012.

### SUMMARY

According to an aspect of the invention, a communication device including: a memory, and a processor coupled to the memory and configured to: perform a data communication in a connection established between the communication device and another communication device based on a first communication protocol, a specified parameter in the first communication protocol being set to a specified value when the connection is started, the specified parameter influencing a data transfer rate of the started connection in a first layer of the first communication protocol, the specified parameter being gradually updated so that the data transfer rate is increased as the communication is performed in the started connection, and when a first connection based on the first communication protocol has been established between the communication device and another specified communication device via a first wireless communication network based on a first radio access technology and when a second connection based on the first communication protocol is started between the communication device and the other specified communication device via a second wireless communication network based on a second radio access technology, start the second connection without closing the first connection, wherein a determination whether to close the first connection is made based on an index value relating a second data transfer rate of the second connection in the first layer of the first communication protocol.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a chart illustrating a processing sequence of a communication system according to a second embodiment;

FIG. 2 is a flow chart illustrating the processing flow of transmission processing of a communication system according to a third embodiment;

FIG. 3 is an illustration depicting the network configuration of the communication system according to the embodiments;

FIG. 4 is a block diagram illustrating the functional configuration of a wireless terminal according to the embodiments;

FIG. 5 is a block diagram illustrating the functional configuration of a server according to the embodiments;

FIG. 6 is a block diagram illustrating the functional configuration of a wireless base station according to the embodiments;

FIG. 7 is a block diagram illustrating the hardware configuration of a wireless terminal according to the embodiments;

FIG. 8 is a block diagram illustrating the hardware configuration of a server according to the embodiments; and

FIG. 9 is a block diagram illustrating the hardware configuration of a wireless base station according to the embodiments.

### DESCRIPTION OF EMBODIMENTS

Under the background mentioned above, data communication performed with a server or the like, for instance, on the Internet using TCP/IP by a wireless terminal capable of utilizing multiple wireless communication systems has been quite commonly practiced for some time, and it seems that no particular problem has occurred. However, the detailed study conducted by the inventor of the present application has revealed an occurrence of a problem in which when predetermined conditions are met, a sufficient throughput is not obtained in the above-mentioned data communication. In view of generally increasing capacity in data communication in recent years, to ensure a sufficient throughput may be considered to be a common challenge in the field of wireless communication.

The technique disclosed herein has been developed in view of the above-mentioned problem, and an object of the disclosure is to provide a communication device, a wireless communication device, and a communication method that are capable of ensuring a sufficient throughput when a wireless terminal capable of utilizing multiple wireless communication systems performs data communication with a server or the like.

Hereinafter, embodiments of a communication device, a wireless communication device, and a communication method in the present disclosure will be described with reference to the drawings. Note that the communication device, the wireless communication device, and the communication method in the present disclosure are not limited by the following embodiments.

[Newly Identified of Problem]

First, before the description of each embodiment is given, where a problem resides in related art will be described. It is to be noted that the problem has been newly found as a result of detailed study of the related art by the inventor of the present application, and has not been previously known.

As already described, data communication with a server or the like on the Internet, for instance, using TCP/IP by a wireless terminal capable of utilizing multiple wireless communication systems (wireless communication methods) has been quite commonly practiced for some time. In order to describe the problem in this case, the concept of connection in TCP will be first described.

TCP achieves one-to-one communication by a connection (TCP connection). The connection is a unitary concept for managing communication between two devices from start to end. Note that although TCP has the concept of session (TCP session), the TCP connection may be replaced by the TCP session in the present application (although the connection and the session are different concepts in a strict sense the different may not be considered so much in the present application).

In general, a TCP connection is identified by the IP address and the TCP port number of each of two devices that communicate (two devices in end-to-end relationship). For instance, a TCP connection for the communication between a wireless terminal and a server is identified by four attributes: the IP address of the wireless terminal, the TCP port number of the wireless terminal, the IP address of the server, and the TCP port number of the server.

Here, the TCP port number is a number for identifying a program (application software) that performs communication in a communication device. In other words, the TCP port number establishes a linkage (correspondence) between a TCP connection and a program utilizing the TCP connection. Note that the TCP port numbers of main services (server-side programs) are officially defined by Internet Assigned Number Authority (IANA). For instance, when a wireless terminal communicates with a Web server, the TCP port number (more accurately, the TCP port number of a Web server program that operates on a WEB server device) of the Web server is generally 80.

As described above, the connection is a unitary concept for managing communication between two devices from start to end. Therefore, as long as the TCP connection is maintained, the two devices manage communication in the TCP connection as a serial communication sequence. More specifically, in the TCP connection, a sequence number (serial number) is assigned to each of packets exchanged. Thus, even if multiple packets in the same connection are not received in the order in which the packets are transmitted, the order of the packets may be restored on a receiving side, and thus the order of the packets is guaranteed.

On the other hand, multiple communication sequences in multiple different TCP connections are independently managed as separate sequences. In other words, when multiple TCP connections are present, a sequence number is assign to a packet in each of the TCP connections. The sequence number, however, may not be synchronized between the TCP connections. This indicates that between different connections, the original order of packets is not guaranteed on the receiving side.

Note that a packet exchanged in a TCP connection is referred to as a TCP packet or a TCP segment. A TCP packet is encapsulated in an IP packet at an IP which serves as a lower protocol, and is transmitted or received. Hereinafter simply called “packet” indicates a TCP packet (TCP segment) unless otherwise stated.

As described at the beginning of the disclosure, the present application deals with the case in which a wireless terminal capable of utilizing multiple wireless communication systems (that is, multiple wireless communication methods) performs data communication with a server using TCP/IP. Hereinafter, a first problem in this case will be described.

As already described, the multiple wireless communication systems are, for instance, a cellular communication system such as LTE and a wireless LAN communication system such as Wi-Fi. Here, a cellular network based on the LTE or the like and a wireless LAN network based on the Wi-Fi or the like are different networks in general. For instance, when an LTE wireless network is provided by a mobile network operator and a Wi-Fi wireless network is provided by a Wi-Fi router (installed in a home, a hot spot or others) connected to a network operator different from the mobile network operator, these are naturally different networks. Also, when an LTE wireless network is provided by a mobile network operator and a Wi-Fi wireless network is provided by a Wi-Fi router connected to the LTE wireless network itself, these are different networks at least on a subnet level.

On the other hand, different networks have different systems (ranges) of IP address in general. This means that even when a wireless terminal is capable of utilizing multiple wireless communication systems, IP addresses assigned to the wireless terminal from multiple networks based on the multiple wireless communication systems are different.

Then different IP addresses inevitably results in different TCP connections. This is because a TCP connection is identified by an IP address and a TCP port number as described above. Therefore, even when a wireless terminal performs communication using multiple wireless communication systems, even if the communication partners are the same server, respective TCP connections based on the multiple wireless communication systems are different.

This means that when a wireless terminal communicates with the same server using multiple wireless communication systems, communications based on the multiple wireless communication systems are managed as different multiple communication sequences. This is because in general, multiple TCP connections are independently managed as separate sequences in a device as described above.

Thus, in a normal framework of TCP, it is difficult to take over a communication sequence between a wireless terminal and a server, for instance, by performing handover between different wireless communication systems (considering the fact that the original meaning of handover is “hand over”, it may be safely stated that this situation indicates substantially incomplete handover between different types of wireless communication systems). Also, in a normal framework of TCP, it is theoretically difficult to distribute a communication sequence between a wireless terminal and a server over the multiple wireless communication systems available by the wireless terminal in a combined use. This is because TCP connections based on multiple wireless communication systems are managed as different connections in TCP. As described previously, in this situation, the original order of packets is not guaranteed on the receiving side between different connections. Therefore, it is difficult in a normal TCP for the receiving side to integrate multiple communication sequences associated with multiple TCP connections while sorting the order.

As described above, when a wireless terminal capable of utilizing multiple wireless communication systems performs data communication using TCP/IP, various problems may arise due to the independence of the multiple TCP connections based on the multiple wireless communication systems. This is the first problem described above.

To cope with this problem, in recent years, a wireless terminal supporting Multipath TCP (MPTCP), which is an upper protocol of TCP, is beginning to be released. In the following, capability of solving the above-mentioned first problem by such a wireless terminal will be described.

MPTCP is a relatively new protocol that was developed in Internet Engineering Task Force (IETF) in January, 2013. In short, MPTCP is a protocol for handling multipath, in other words, multiple TCP connections in a unified manner.

MPTCP has a function of integrating multiple TCP connections based on conventional TCP which is a lower protocol. This function is achieved in a single MPTCP connection including multiple TCP connections by assigning unified (consolidated) sequence numbers to the packets transmitted/received in the multiple TCP connections. This allows the receiving side to integrate the multiple communication sequences associated with the multiple TCP connections while sorting the order.

Here, as described above, it is to be noted that MPTCP is a protocol based on the conventional TCP. This means that even when MPTCP is used, the conventional TCP operates in a normal manner in the background of the MPTCP. Therefore, for instance, assignment of unified sequence numbers in an MPTCP connection still allows individual sequence numbers (in the conventional TCP) to be assigned in each of the multiple TCP connections included in the MPTCP connection.

In order for a wireless terminal to utilize the function of MPTCP, it is insufficient that MPTCP is supported only by the wireless terminal, and it is preferable that MPTCP be supported, for instance, by a device (such as a server) which is a communication partner of the wireless terminal. Even if MPTCP is not supported by a device which a communication partner, the function of MPTCP is available for the wireless terminal if MPTCP is supported by one of relay devices between the wireless terminal and the communication partner. Such relay devices include, for instance, Packet Data Network Gateway (PDN-GW) in Evolved Packet Core (EPC) which is the core network of the LTE.

Like this, when a wireless terminal utilizes the function of MPTCP, it is sufficient that MPTCP be supported by one of devices between the wireless terminal and the communication partner. Also, as described above, MPTCP is a protocol based on the conventional TCP, which means MPTCP is a protocol that does not modify TCP. Thus, MPTCP also has the advantage that MPTCP may be introduced by minimum amount of modification of an existing network.

In the framework of MPTCP, a TCP connection is referred to as a subflow in some cases. Also, a sequence number (in the conventional TCP) assigned by a TCP connection is referred to as a subflow sequence number (SSN) in some cases. On the other hand, a unified sequence number assigned by an MPTCP connection is referred to as a data sequence number (DSN) in some cases.

With the MPTCP described above, it is possible to solve the first problem (mentioned above) in the conventional TCP. As already described, MPTCP allows the receiving side to integrate the multiple communication sequences associated with multiple TCP connections while sorting the order. Therefore, when a wireless terminal capable of utilizing multiple wireless communication systems performs data communication using TCP/IP, the multiple TCP connections based on the multiple wireless communication systems may be managed as a single MPTCP connection in a unified manner.

Thus, even when a wireless terminal capable of utilizing multiple wireless communication systems performs data communication using TCP/IP, various problems accompanied by the independence of multiple TCP connections are solved. For instance, it is possible to achieve take-over of a communication sequence between a wireless terminal and a server by performing handover between different wireless communication systems using MPTCP. In short, use of MPTCP enables original handover between different types of wireless communication systems to be achieved. In addition, MPTCP achieves distribution of a communication sequence between a wireless terminal and a server by using the multiple wireless communication systems available by the wireless terminal in combination.

Consequently, MPTCP solves the first problem described above. Thus, it seems that no particular problem arises when a wireless terminal capable of utilizing multiple wireless communication systems performs data communication using TCP/IP. However, the inventor of the present application claims the existence of a second problem which is not solved even with the use of MPTCP. The second problem has been found by the inventor of the present application.

In the following, as the preparation for describing the second problem mentioned above, a window size which is a parameter in TCP and congestion control of TCP will be sequentially described.

As described at the beginning of the disclosure, TCP performs various types of control to ensure the reliability of communication. One of such control is retransmission control. For instance, a case is discussed in which a wireless terminal transmits a data packet (such as an HTTP request) to a server. When the server is successful in receiving the data packet from the wireless terminal, the server transmits an acknowledgement (ACK) packet, which is control information indicating successful reception, to the wireless terminal. The wireless terminal, when receiving an ACK packet, transmits another data packet to the server as desired. On the other hand, when the wireless terminal does not receive an ACK packet within a predetermined time, reception of the data packet by the server is assumed to be unsuccessful (in short, packet loss has occurred), and the wireless terminal retransmits the data packet to the server. In this manner, it is possible for the wireless terminal to ensure reliable reception of the data packet by the server. This is an outline of retransmission control in TCP.

Next, a situation is assumed in which the wireless terminal desires to transmit data with a large size (such as a video file) to a server. In TCP, a maximum segment size (MSS) is defined as the amount (the number of bytes) of data which may be transmitted per packet, and thus data with a large size is divided according to the MSS then transmitted. It is assumed that the terminal desires to transmit N data packets to a server.

In this situation, when the following sequence occurs: a first data packet is transmitted an ACK packet for the first data packet is received a second data packet is transmitted an ACK packet for the second data packet is received . . . , it takes at least the time N×RTT until transmission of all data packets is completed where the RTT (round trip time) is the time taken for a signal to travel between two devices.

It is probably inefficient to transmit N data packets sequentially one by one in this manner. However, for instance if N data packets are transmitted at a time, some data packets may be discarded due to overflow of a buffer on the receiving side, and accordingly retransmission may often occur, which is also inefficient.

Thus, in TCP, the size of a data packet (called a window or a congestion window) which may be transmitted without waiting for an ACK from the partner is defined as a parameter. The parameter is called a window size. The value (to be accurate, the upper limit as described later) of window size is set according to a request from a communication partner in three-way handshake which is a predetermined exchange (procedure) when a TCP connection is established. The above-mentioned control based on the window size in TCP may be called a window control.

It is to be noted that although the number of data packets is used in the above description for the purpose of simplification, to be accurate, the actual window size of TCP is specified by the total number of bytes of data packets (segments) and not by the number of data packets. That is, when the value of window size is set to CWND in a wireless terminal, the wireless terminal may transmit data packets up to CWND bytes in total without waiting for an ACK packet from the server. Note that in general, CWND is set to an integral multiple of the above-mentioned MSS. Thus, assuming that CWND=n×MSS (n is a positive integer), CWND bytes of data is transmitted as n data packets each of which has MSS bytes.

Setting the window size to an appropriate value allows some data packets to be transmitted together. Since the window size is set according to a request from a communication partner as described above, there is less chance of inducing overflow of a buffer of the communication partner such as mentioned above due to a too large setting value. Therefore, it is probable that the window size allows the efficiency of TCP communication to be properly ensured.

However, when the wireless terminal desires to transmit data with a large size to a server, it is probable that transmitting data packets for the window size all the time may cause a problem. For instance, congestion may occur in a network between the wireless terminal and the server, and some packets may be discarded due to overflow of a buffer in one of relay devices between the wireless terminal and the server. This is because although the window size is set according to a request of a communication partner, the condition of the relay devices is not taken into consideration. Similarly to the case in which packets are discarded in a communication partner (such as a server), if packets are discarded in a relay device, retransmission may often occur and thus efficient TCP communication is inhibited.

Thus, TCP has a congestion control function in order to avoid such a problem.

Now, a situation is assumed in which a wireless terminal desires to transmit data with a large size to a server and a TCP connection is not established yet between the wireless terminal and the server. In such a situation, the wireless terminal and the server first perform the three-way handshake described above, and achieve (start) a TCP connection. At this point, as described above, a window size, which is a parameter of TCP, is set in the wireless terminal according to a request from the server. Let CWND be a window size set in the wireless terminal (note that the window size is mutually set and is also set in the server according to a request from the wireless terminal).

In this process, when the convenience of only the server as a communication partner is taken into consideration, the wireless terminal may transmit CWND bytes of data together to the server based on the value of window size set in the three-way handshake. However, in consideration of possibility of congestion in a network as described above, the wireless terminal adjusts (increases or decreases) the window size in an initial stage without setting the window size to CWND bytes from the start.

Specifically, for instance, the wireless terminal sets an initial value of the window size to 1×MSS, and transmits a data packet with a size of MSS bytes to the server. The wireless terminal, when receiving an ACK packet from the server, doubles the window size and transmits two data packets each with a size of MSS bytes to the server. In addition, the wireless terminal, when receiving an ACK packet from the server, further doubles the window size and transmits four data packets each with a size of MSS bytes to the server. By repeating this process, the window size is updated gradually like 4×MSS→8×MSS→ . . . , and the wireless terminal exponentially increases the amount of data to be transmitted together.

In this manner, in an initial stage of the congestion control of TCP, the window size is increased exponentially, that is, relatively rapidly. Subsequently, when the window size reaches a predetermined threshold value, the rate of increase in the window size is reduced. This is measures in consideration of increasing possibility of packet discard due to congestion once the window size reaches a certain level.

Specifically, for instance, when the above-mentioned predetermined threshold value is 16×MSS and the window size reaches 16×MSS bytes, the wireless terminal does not double the window size like previously but increases the window size, for instance, by MSS bytes to obtain 17×MSS, and transmits 17 data packets each with a size of MSS bytes to the server. Subsequently, every time the wireless terminal receives an ACK packet from the server, the window size is updated gradually like 17×MSS→18×MSS→19×MSS . . . , and the wireless terminal linearly increases the amount of data to be transmitted together.

The mechanism, in which the initial value of window size is set to a relatively small value and subsequently the window size is increased exponentially as described above, is called a slow start. The slow start is known as a term indicating the congestion control of TCP clearly and simply. Also, a stage, in which the window size is increased relatively rapidly (exponentially) based on the slow start, is called a slow start phase. On the other hand, a stage, in which the window size is increased relatively slowly (linearly), is called a congestion avoidance phase.

It is to be noted that CWND, which is a value of window size set in three-way handshake, is actually an upper limit of the window size. That is, if the process goes smoothly by repeating the procedure described above, the window size sooner or later reaches CWND bytes which is an upper limit.

However, it may be presumed that the process does not go smoothly. For instance, let's assume a case in which when the window size is 8×MSS in a slow start phase, a wireless terminal transmits a data packet to a server based on the window size, and an ACK packet is not received from the server within a predetermined time (in short, packet loss has occurred). In this case, for instance, the wireless terminal sets the window size to 4×MSS which is half the last window size, and (even when the window size is less than or equal to the predetermined threshold value mentioned above) the wireless terminal causes a transition from a slow start phase to a congestion avoidance phase. From this point forward, the window size is relatively slowly increased linearly.

In this manner, in a situation where congestion has not occurred between the wireless terminal and the server, data packets may be transmitted based on the upper limit (CWND which is a value set when three-way handshake is performed) of the window size. On the other hand, in a situation where congestion has occurred between the wireless terminal and the server, the value of window size may be adjusted according to the degree of congestion. Consequently, efficient TCP communication may be performed according to a situation.

It is to be noted that what has been presented is an example of the congestion control of TCP, and the congestion control has various implementations (algorithms) and the above-described procedure is only an example. For instance, in the aforementioned example, when an ACK packet is not received from the server, the window size is halved. However, some implementations allow the window size to be reduced to 1. In addition, some implementations allow the window size to be adjusted based on the RTT mentioned above.

However, in any implementation of the congestion control of TCP, the following procedure is common: when a TCP connection is established, the window size is set to a relatively small initial value, and later, the value of the window size is gradually updated to be increased as transmission and reception of a packet is repeated. Thus, the throughput (the amount of data transferred per unit time) of TCP is regulated to a relatively low level for a certain amount of time from the start time of a TCP connection until certain volume of data communication is completed. Such a behavior in TCP communication is probably caused by the slow start described above.

Although a long introduction has been given, the discussion returns to the case in which a wireless terminal capable of utilizing multiple wireless communication systems performs data communication using TCP/IP. In this case, as described previously, the above-described first problem is solved by using MPTCP. However, as described above, the second problem exists which is not solved even with the use of MPTCP.

Hereinafter, the second problem will be described. Specifically, handover between different wireless communication systems (handover between different types of wireless communication systems) is discussed. As already described, use of MPTCP enables original handover between different types of wireless communication systems to be achieved. This is because with MPTCP, multiple communication sequences associated with two TCP connections corresponding to a handover source and a handover destination may be managed by the receiving side in a unified manner.

However, as mentioned previously, MPTCP is a protocol based on the conventional TCP. This means that even when MPTCP is used, the conventional TCP operates in a normal manner in the background of the MPTCP.

Therefore, when handover is performed between different types of wireless communication systems, even when MPTCP is used, switching between TCP connections occurs in the background. Specifically, at the moment when a TCP connection based on the wireless communication system of a handover source is completed, a TCP connection based on the wireless communication system of a handover destination is newly established (started).

Since the TCP connection of a handover destination is newly established, the procedure for the above-described three-way handshake has to be followed. In general, the three-way handshake takes a certain time, and thus a certain time lag (delay) occurs before transmission/reception of a data packet starts in a TCP connection of a handover destination. Thus, after all, a time lag occurs in a unified communication sequence handled by an MPTCP connection, which is not preferable.

A further serious problem lies in the slow start described above. Since the TCP connection associated with a handover destination is newly established, after three-way handshake, the window size is set to a relatively small initial value due to the congestion control of TCP. The throughput is semi-forcibly regulated to a relatively low level by the mechanism of the slow start for a certain amount of time from the start time of the TCP connection until certain volume of data communication is completed.

This causes a problem in that the throughput of TCP communication suddenly drops prior to or subsequent to handover between different types of wireless communication systems, and it takes time for subsequent recovery of the throughput. If TCP communication is performed based on the upper limit of the window size or a value close to the upper limit in a TCP connection of a handover source, this problem has a further adverse effect.

Like this, when handover is performed between different types of wireless communication systems, a problem arises in that a throughput after the handover may not be ensured due to the slow start in the congestion control of TCP. This is the second problem mentioned previously. As described above, the second problem is different from the first problem and may not be solved by MPTCP.

It is to be noted that although the above description has been given based on the TCP and MPTCP as an example, if predetermined conditions are met, other protocols are applicable.

The summary of the above is as follows: when a wireless terminal performs TCP communication with a server or the like and handover is performed between different types of wireless communication systems, there is a problem in that communication sequences of two TCP connections prior to or subsequent to the handover may not be managed in a unified manner. Although this problem has been solved with the advent of MPTCP in recent years, another problem still remains to be unsolved, that is, a throughput after handover may not be ensured due to the slow start in the congestion control of TCP. As described at the beginning of the disclosure, this problem has been newly found as a result of detailed study of the related art by the inventor of the present application, and has not been previously known.

In the following, the embodiments which solve this problem will be sequentially described.

### First Embodiment

A communication device (for instance, a server) in a first embodiment according to the disclosure includes: a communication unit configured to perform communication; and a control unit configured to control data communication to be performed using the communication unit, based on a first communication protocol (for instance, TCP) which performs data communication in a connection (for instance, a TCP connection) established by the communication device between a communication destination device and the communication device, and in which a predetermined parameter (for instance, a window size), which affects an amount of data transfer per unit time in a layer of the first communication protocol of the connection, is set to a predetermined value at a start of the connection, and the predetermined parameter is gradually updated to increase the amount of data transfer per unit time as communication is performed in the connection, wherein the control unit, when a first connection based on the first communication protocol is set via a first wireless network (for instance, an LTE) based on a first wireless communication system between the communication device and a wireless communication device (for instance, a wireless terminal) which is a communication destination device, and a second connection based on the first communication protocol is started via a second wireless network (for instance, a Wi-Fi) based on a second wireless communication system between the communication device and the wireless communication device, starts the second connection without closing (or ending or closing) the first connection, and determination as to whether or not the first connection is closed is made based on an index value (for instance, a throughput) relating to an amount of data transfer per unit time of the second connection in the first communication protocol.

The technical significance of the first embodiment will be described. As described above, in the related art, a problem arises in that when handover is performed between different types of wireless communication systems, a throughput after the handover may not be ensured. It is probable that the main cause of this problem eventually lies in the process in which a TCP connection is immediately switched when handover is performed between different types of wireless communication systems.

That is, since a TCP connection is switched during handover between different types of wireless communication systems in the related art, the TCP connection of a handover source is completed substantially at the same time with the start of the TCP connection of a handover destination. In this case, the TCP connection of a handover destination is newly started, and thus it is inevitable that based on the slow start of TCP, the throughput of the connection in an initial stage is forcibly regulated to a relatively low value and it takes time for subsequent increase in the throughput. On the other hand, it may be presumed that the throughput of the TCP connection of a handover source, which has completed in exchange for the handover destination, is a relatively high value except for the case where congestion has occurred. For this reason, the throughput suddenly drops prior to or subsequent to the handover and it takes time for recovery of the throughput, and the problem described above probably arises.

Thus, in the first embodiment, when handover is performed between different types of wireless communication systems, a TCP connection is not immediately switched, and the TCP connection of a handover destination is started without closing the TCP connection of the handover source. In other words, the TCP connection of a handover destination is established while maintaining the TCP connection of the handover source. In addition, in the first embodiment, the TCP connection of a handover source is closed based on whether or not at least a certain amount of throughput is ensured in the TCP connection of a handover destination. More specifically, for instance, when the throughput of the TCP connection of a handover destination reaches a predetermined value, the TCP connection of a handover source is closed.

Consequently, according to the first embodiment, when handover is performed between different types of wireless communication systems, both TCP connections of a handover source and a handover destination may be temporarily used at the same time (concurrently). At this point, the throughput in an initial stage is regulated to a relatively low value in the TCP connection of a handover destination as already described. However, even in the stage, the TCP connection of a handover source with a relatively high throughput may be used, and thus as in the related art, drop of the throughput between the communication devices is avoidable when the TCP connection of the handover destination is started. It is to be noted that the throughput across devices is not the throughput of each of individual TCP connections, but the throughput in an MPTCP layer that integrates the TCP connections.

Furthermore, according to the first embodiment of the present application, for instance, after the slow start phase is over and the throughput in the TCP connection of a handover destination reaches a predetermined value, the TCP connection of a handover source may be closed. Subsequently, TCP communication may be performed by the TCP connection of the handover destination with a throughput higher than at the start of the TCP connection. In this manner, it is possible to avoid drop of the throughput accompanied by the closing of the TCP connection of the handover source.

Consequently, according to the first embodiment, it is possible to solve the above-described problem in the related art. Specifically, according to the first embodiment, it is possible to avoid the problem that the throughput of TCP communication suddenly drops prior to or subsequent to handover between different types of wireless communication systems, and it takes time for subsequent recovery of the throughput. Thus, when handover is performed between different types of wireless communication systems, it is possible to ensure the throughput after the handover.

It is to be noted that although the above description has been given based on the TCP and MPTCP as an example, if predetermined conditions are met, the present disclosure is applicable to other protocols.

It is to be noted that although the above description has been given based on handover between different types of wireless communication systems from a cellular network based on LTE to a wireless LAN network based on Wi-Fi, as an example, if predetermined conditions are met, the present disclosure is applicable to handover between other different types of wireless communication systems.

The summary of the above is as follows: in the first embodiment, when handover is performed between different types of wireless communication systems by a wireless terminal, a TCP connection is not immediately switched, and the TCP connection of a handover destination is started without closing the TCP connection of a handover source. In addition, in the first embodiment, the TCP connection of a handover source is closed based on whether or not at least a certain amount of throughput is ensured in the TCP connection of a handover destination. Thus, according to the first embodiment, it is possible to solve the problem in the related art, that is, when handover is performed between different types of wireless communication systems, a throughput after the handover may not be ensured.

### Second Embodiment

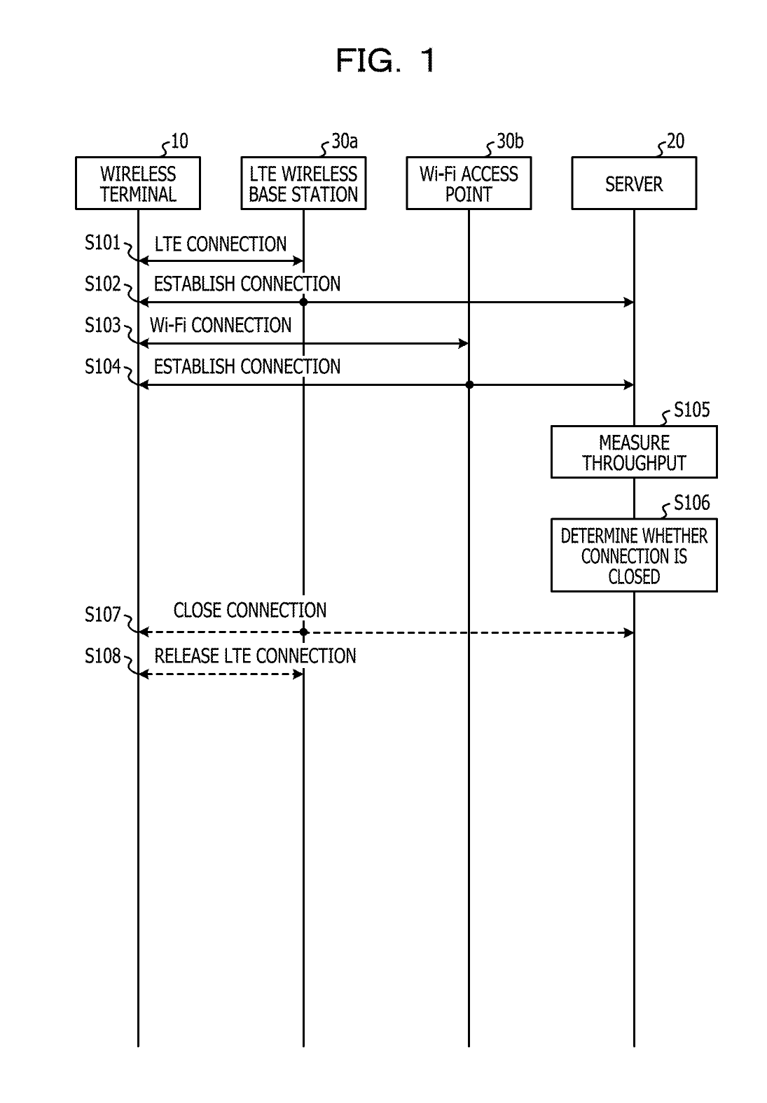

Hereinafter, a second embodiment will be described with reference to FIG. 1. The second embodiment corresponds to the case in which the first embodiment is specifically applied to a wireless terminal that uses TCP and MPTCP. However, it is to be noted that the present disclosure is not limited to these communication protocols, and is applicable to wireless communication systems based on other communication protocols similarly.

Also, in the second embodiment, description is given by assuming a wireless terminal capable of utilizing LTE and Wi-Fi which serve as a specific example of multiple wireless communication systems (wireless communication methods). However, it goes without stating that these are only an example and the present disclosure is applicable to other multiple wireless communication systems similarly. However, it is to be noted that the multiple wireless communication systems given in the present application are assumed to have different IP addresses assigned to a wireless terminal as already described.

The present disclosure is directed to a wireless terminal capable of utilizing multiple wireless communication systems, and such a wireless terminal is able to use only one of the multiple wireless communication systems singly or use them in a combined manner as described above. Here, one of these two modes of use (single use or combined use) is selectively set according to time and circumstances, and in the present embodiment, it is assumed that “single use” is selected in a wireless terminal. Here, the selection may be made, for instance, based on manual setting by a user in a wireless terminal, or for instance, in the case in which the wireless terminal has a relatively large remaining amount of a battery, combined use may be autonomously selected, and in the case in which the wireless terminal has a relatively small remaining amount of a battery, single use may be autonomously selected.

FIG. 1 is a chart illustrating a processing sequence according to the second embodiment.

In S101 of FIG. 1, a wireless terminal 10 is connected to an LTE wireless network. Execution of S101 is triggered by, for instance, start-up (power supply is turned ON) of the wireless terminal 10. S101 allows the wireless terminal 10 to perform MPTCP communication and/or TCP communication using the LTE wireless network via a wireless base station 30a of LTE (hereinafter may be referred to as a first wireless base station 30a for the sake of convenience). Note that in general, a wireless base station of LTE is called an evolved Node B (eNB). A specific processing procedure of S101 may follow an existing connection procedure (protocol specification) in LTE, and thus a description thereof is omitted.

In S102 of FIG. 1, the wireless terminal 10 and a server 20 establish (start) an MPTCP connection and a TCP connection belonging to the MPTCP connection via the LTE wireless network connected in S101. Execution of S102 is triggered by, for instance, an issuance of an access request (such as an HTTP request for transmission) in the wireless terminal 10 to the server 20. In or after S102, the wireless terminal 10 and the server 20 perform data communication (such as transmission/reception of a Web page, which is an HTTP request or an HTTP response) as desired based on the established MPTCP connection and TCP connection. A specific processing procedure of S102 may follow an existing connection establishment procedure (protocol specification) in MPTCP and TCP, and thus a description thereof is omitted.

In S103 of FIG. 1, the wireless terminal 10 is connected to a Wi-Fi wireless network. Execution of S103 is triggered by, for instance, entry of the wireless terminal 10 into the service provision area of the Wi-Fi wireless network. Here, the wireless terminal 10 may detect entry to the service provision area of the Wi-Fi wireless network by receiving a predetermined signal from a Wi-Fi access point 30b (hereinafter may be referred to as a second wireless base station 30b for the sake of convenience). S103 allows the wireless terminal 10 to perform MPTCP communication and/or TCP communication using the Wi-Fi wireless network via the Wi-Fi access point 30b. A specific processing procedure of S103 may follow an existing connection procedure (protocol specification) in Wi-Fi, and thus a description thereof is omitted.

Here, as described above, it is assumed that the wireless terminal 10 according to the present embodiment is set so as to use only one of the multiple wireless communication systems singly. However, it is to be noted that in S103, the wireless terminal 10 is connected to the Wi-Fi wireless network without disconnecting the LTE wireless network connected in S101. This allows both networks to be temporarily used concurrently (or at the same time) when switching is performed between the multiple wireless communication systems.

In S104 of FIG. 1, the wireless terminal 10 and the server 20 establish a new TCP connection via the Wi-Fi wireless network connected in S103 under the MPTCP connection established in S102. In other words, the wireless terminal 10 and the server 20 add a TCP connection via the Wi-Fi wireless network to the MPTCP connection established in S102. A specific processing procedure of S104 may follow an existing technique (specification) in MPTCP and TCP, and thus a description thereof is omitted.

Here, it is to be noted that in S104, the wireless terminal 10 establishes a TCP connection via the Wi-Fi wireless network without closing the TCP connection via the LTE wireless network established in S102. This allows the wireless terminal 10 and the server 20 in or after S104 to perform data communication using two TCP connections belonging to one MPTCP connection concurrently (or at the same time). As described above, in MPTCP of a data transmission device, a DSN (mentioned above), which is a unified sequence number, is assigned to each of data packets transmitted over multiple TCP connections, and in MPTCP of a data reception device, the data packets received over multiple TCP connections may be sorted based on the DSN (mentioned above).

In S105 of FIG. 1, the server 20 measures (calculates) a throughput at least in the TCP connection via the Wi-Fi wireless network. Calculation of a throughput may be performed using, for instance, CWND/SRTT (byte/sec) where CWND is the window size described above. Also, a smooth round trip time (SRTT) is a moving average deviation of the above-described RTT and specifically, may be determined by SRTTₙ₊₁=α×RTTₙ₊₁+(1−α)×SRTTₙ, where a is a predetermined value between 0 and 1 and SRTT₀=RTT₀. Note that to calculate a throughput, for instance, the last RTT may be used without using SRTT.

The timing for measurement of a throughput in S105 may be given, for instance, by the timing for transition of the TCP connection via the Wi-Fi wireless network from the slow start phase to the congestion avoidance phase. This is because the increase of the window size is relatively slow in the congestion avoidance phase as described above, and thus the increase of the throughput is also relatively slow (that is, the throughput is relatively stabilized). Here, as described above, the conditions for the transition of phase in the congestion control of TCP connection are as follows: the window size reaches a predetermined threshold value or packet loss occurs. Note that the measurement of a throughput in S105 may be performed after an elapse of a predetermined time from establishment of a TCP connection via the Wi-Fi wireless network, for instance.

In S106 of FIG. 1, the server 20 decides (determines) whether or not the TCP connection via the LTE wireless network is to be closed, based on the throughput, measured in S105, in at least the TCP connection via the Wi-Fi wireless network. For instance, the server 20 may determine that the connection via the LTE wireless network is to be closed when the throughput in the TCP connection via the Wi-Fi wireless network is higher than or equal to a predetermined value. On the other hand, the server 20 may determine that the TCP connection via the LTE wireless network is to be maintained when the throughput in the TCP connection via the Wi-Fi wireless network is lower than the predetermined value. Thus, it is possible to ensure the throughput in the newly established TCP connection via the Wi-Fi wireless network.

Here, in S106, the server 20 determines that the TCP connection via the Wi-Fi wireless network is to be closed. Note that the processing in S105, S106 may be repeated cyclically until closing of the TCP connection is determined in S106.

In S107 of FIG. 1, the wireless terminal 10 and the server 20 close the TCP connection based on the determination of S106. For instance, when it is determine that the TCP connection via the LTE wireless network is to be closed in S106, the wireless terminal 10 and the server 20 close the connection in S107. Thus, the TCP connection via the Wi-Fi wireless network is the only one TCP connection belonging to the MPTCP connection between the wireless terminal 10 and the server 20. A specific processing procedure of S107 may follow an existing connection closing procedure (protocol specification) in TCP, and thus a description thereof is omitted.

In S108 of FIG. 1, the wireless terminal 10 releases the connection to the LTE wireless network. In other words, the wireless terminal 10 is disconnected from the LTE wireless network. Thus, the Wi-Fi wireless network is the only one wireless network to which the wireless terminal 10 is connected. In other words, handover between different types of wireless communication systems from the LTE wireless network to the Wi-Fi wireless network is completed in the wireless terminal 10. A specific processing procedure of S108 may follow an existing connection release procedure (protocol specification) in LTE, and thus a description thereof is omitted.

The processing sequence in the second embodiment has been described above, and various modifications of the processing sequence will be described in the following. It goes without stating that these modifications may be combined with each other.

First, the processing of S105 to S108 described above is an example, and alternatively, the following processing may be performed, for instance. First, in S105, in addition to the throughput in the TCP connection via the Wi-Fi wireless network, the throughput in the TCP connection via the LTE wireless network is also measured. In S106, two throughputs measured in S105 are compared and the TCP connection for a lower throughput is determined to be closed. Furthermore, one of the TCP connections is closed in S107 based on the determination of S106, and connection to one of the wireless networks is released in S108.

In this manner, when the wireless terminal 10 connected to the LTE wireless network is relocated to the service provision area of the Wi-Fi wireless network, it is possible to avoid a situation in which handover to the Wi-Fi wireless network is performed even though the throughput of the Wi-Fi wireless network may not be ensured.

Next, the processing sequence described above illustrates the case in which MPTCP communication is performed between the wireless terminal 10 and the server 20 under the assumption that the server 20 is able to interpret MPTCP. However, when MPTCP communication is performed between the wireless terminal 10 and a relay device, the processing sequence may be similarly achieved. Any relay device is applicable as long as the relay device is located between the wireless terminal 10 and the server 20 and is able to interpret MPTCP. In this case, the relay device uses an MPTCP connection between itself and the wireless terminal 10 and a TCP connection between itself and the server 20 (without using an MPTCP connection), thereby relaying data communication between the wireless terminal 10 and the server 20. For instance, the PDN-GW mentioned above may be operated as such a relay device.

In S105, S106 described above, the server 20 measures a throughput, and determines closing of the TCP connection. However, such processing may be performed by the wireless terminal 10, for instance.

Furthermore, in S105, S106 described above, the throughput in the TCP connection is used as an index for determining closing of the TCP connection. However, as the index, another parameter related to (affecting on) the throughput of the TCP connection may be used. As an example, the above-described window size may be used as the index.

Finally, the processing sequence of FIG. 1 illustrates the case in which handover is performed between different types of wireless communication systems from the LTE wireless network to the Wi-Fi wireless network. It goes without stating that handover may be performed between different types of wireless communication systems from the Wi-Fi wireless network to the LTE wireless network in a similar manner. In that case, processing of connection (corresponding to S103) to the LTE wireless network performed by the wireless terminal 10 connected to the Wi-Fi wireless network is triggered by, for instance, exit of the wireless terminal 10 from the service provision area of the Wi-Fi wireless network. The wireless terminal 10 may detect exit from the service provision area of the Wi-Fi wireless network by not receiving a predetermined signal from the Wi-Fi access point (or by decrease of received power to a level less than a predetermined value).

According to the second embodiment described above, similarly to the first embodiment, when handover is performed between different types of wireless communication systems by the wireless terminal 10, the TCP connection is not immediately switched, and the TCP connection of a handover destination is started without closing the TCP connection of a handover source. In addition, in the second embodiment, the TCP connection of a handover source is closed based on whether or not at least a certain amount of throughput is ensured in the TCP connection of a handover destination. Thus, according to the second embodiment, it is possible to solve the problem in the related art, that is, when handover is performed between different types of wireless communication systems, a throughput after the handover may not be ensured.

### Third Embodiment

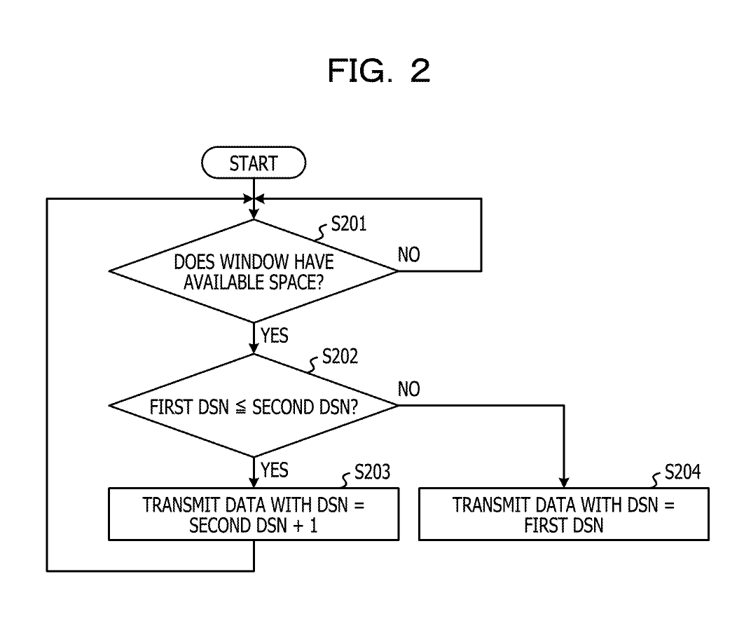

Hereinafter, a third embodiment will be described with reference to FIG. 2. The third embodiment corresponds to a modification of the second embodiment. In short, in the third embodiment, MPTCP packets, which are generated based on the same data and have the same DSN, are repeatedly transmitted/received in each of multiple TCP connections, thereby solving problems caused by buffer overflow in a reception device.

The third embodiment has many points in common with the second embodiment described above. Hereinafter, in the third embodiment, point of difference from the second embodiment will be mainly described.

In the second embodiment described above, in S104 to S107 of FIG. 1, data communication is performed between the wireless terminal 10 and the server 20 using two TCP connections belonging to the MPTCP connection concurrently (or at the same time). In this process, as described above, in MPTCP of a data reception device, the data packets received over multiple TCP connections may be sorted based on the DSN (mentioned above) which is a unified sequence number assigned by MPTCP to each of packets.

Here, MPTCP of the reception device passes data taken from the received data packets to a program (application software) that uses the data in a predetermined cycle (periodic or aperiodic interval). However, when the data packets received in a certain cycle has a missing packet (in other words, when there is a missing number in the DSNs of data packets received in the cycle), the reception device does not sort and pass the data packets in the cycle to a program. The data packets in the cycle and the data packets received in the subsequent cycle continue to be held in a buffer until missing data is recovered. Thus, a program, which uses data, is capable of utilizing data without coping with missing data in a network.

However, with such a specification in MPTCP, if, for instance, the difference in throughput (or difference in delay) between the multiple TCP connections belonging to MPTCP is relatively large, a problem may occur. For instance, when one of data packets transmitted in one TCP connection which is slower than the other arrives with long delay, many packets are held in a buffer of the reception device for the one packet, and buffer overflow may be caused. When buffer overflow occurs, it goes without saying that subsequent data is unable to be received and accordingly transmission of data is unable to be performed as desired in many cases (this is because in general, client/server 20 application determines data to be transmitted next based on the data received from a partner). As a result, there is a possibility that a throughput (throughput of MPTCP) between the devices may be reduced. When transmission of data is unable to be performed, the window size is not increased, and thus in the second embodiment, time taken to use two wireless communication systems is increased, which causes a problem in that the consumption of a battery of the terminal is affected. Also, delay in passing data to the program may adversely affect data processing by the program.

However, if no data communication is performed using slower one of the multiple TCP connections belonging to MPTCP in order to avoid the above-mentioned problem, another problem occurs. In many cases, the slower TCP connection corresponds to the TCP connection established later (for instance, the TCP connection via the Wi-Fi wireless network in FIG. 1). Therefore, if no data communication is performed using the TCP connection, the window size of the TCP connection is not increased and the throughput of the TCP connection never increases. This is preposterous approach.

Thus, in the third embodiment, while two TCP connections belonging to an MPTCP connection are used concurrently, MPTCP packets, which are generated based on the same data and have the same DSN, are transmitted/received in both two TCP connections redundantly. In a reception device, out of the packets received redundantly, the first received one is used to sort the packets and pass the packets to a program, and the later received one is discarded.

Thus, according to the third embodiment, even when the difference in throughput between the multiple TCP connections belonging to MPTCP is relatively large, by using data packets transmitted/received via a faster TCP connection, the reception device is able to sort the data packets and pass the data packets to a program. Thus, it is possible to solve the above-described problems caused by an increase in buffer holding time in the reception device. In addition, according to the third embodiment, transmission/reception of data packet is performed also in the slower TCP connection, and thus the above-described problem caused by not using the slower TCP connection is also solved. Thus, according to the third embodiment, it is probable that the second embodiment may be achieved more effectively.

In the description above, the case has been described in which MPTCP packets, which are generated based on the same data and have the same DSN, are transmitted/received in both two TCP connections redundantly. However, it is also possible to obtain a similar effect by transmitting or receiving a dummy packet. Specifically, the transmission device transmits normal data packets successively in one with a higher throughput out of two TCP connections, and transmits dummy packets (may be an empty sequence or a random number sequence) in the other one with a lower throughput. The reception device then discards the dummy packets. Thus, it is possible to obtain a similar effect to that of the above-described duplicate transmission of a packet.

The processing of a transmission device for data packet in the third embodiment will be described based on FIG. 2. The processing flow of FIG. 2 is performed in one with a relatively lower throughput out of two TCP connections belonging to an MPTCP connection, that is, in general, the TCP connection established later (for convenience, referred to as a second TCP connection). Note that in the TCP connection with a relatively higher throughput, that is, in general, the TCP connection established first (for convenience, referred to as a first TCP connection), general transmission processing such as incrementing DSN every time a data packet is transmitted, rather than the processing flow of FIG. 2 is performed.

In FIG. 2, it is assumed that data to be transmitted is present in a transmission device (for instance, the wireless terminal 10 or the server 20). The data for transmission includes, for instance, HTTP request generated by a Web browser (program) that operates in the wireless terminal 10, and HTTP response (Web page) generated by Web server 20 (program) that operates in the server 20.

The transmission device in S201 of FIG. 2 determines whether the window (congestion window) of the second TCP connection has available space. This is equivalent to determining whether or not data may be transmitted in the second TCP connection. This is because when the window of a TCP connection has available space in the TCP connection, data may be transmitted with an upper limit of the window size as described above.

In S201, when the window has available space, the flow proceeds to S202. On the other hand, when the window has no available space, processing S201 is performed again after a predetermined time, for instance.

In S202 of FIG. 2, the transmission device compares DSNs of two TCP connections belonging to the MPTCP connection. Specifically, the comparison is made in the following manner. First, the transmission device obtains the DSN (referred to as a second DSN for convenience) of a data packet for which transmission is completed last in the second TCP connection. Here, “transmission is completed” indicates a state in which after a data packet is sent, ACK corresponding to the data packet has been received. On the other hand, concurrently with this, the transmission device obtains the DSN (referred to as a first DSN for convenience) of a leading data packet during transmission in the first TCP connection. Here, “during transmission” indicates a state in which after a data packet is sent, ACK corresponding to the data packet has not been received.

The transmission device then compares the first DSN with the second DSN. When the second DSN is greater than or equal to the first DSN, the flow proceeds to S203 of FIG. 2. On the other hand, when the second DSN is less than the first DSN, the flow proceeds to S204 of FIG. 2.

In S203 of FIG. 2, the transmission device transmits a data packet with a DSN of “the second DSN+1” in the second TCP connection. Here, as described above, S203 is executed when the second DSN is greater than or equal to the first DSN. In this case, it is to be noted that the second connection does not have to transmit data packets with the second DSN or less, for which transmission is already completed in the second connection.

On the other hand, in S204 of FIG. 2, the transmission device transmits a data packet with a DSN of “the first DSN” in the second TCP connection. Here, as described above, S204 is executed when the second DSN is less than the first DSN. In this case, it is to be noted that the second connection has to transmit the data packet with the first DSN, which is during transmission in the first connection.

Note that in each of S203 and S204 of FIG. 2, the SSN of a data packet to be transmitted is set to the second SSN. Here, the second SSN is the value obtained by adding one to the SSN which is set to the data packet transmitted last in the second TCP connection.

In each of S203 and S204 of FIG. 2, the flow returns to S201.

By performing the transmission processing of data packet as described above, it possible for the reception device to maintain a throughput without being affected by reversed order of data.

Furthermore, in the third embodiment, the following processing may be performed.

When one of the two TCP connections belonging to the MPTCP connection is closed (corresponding to S108 of FIG. 1), straightforward closing may cause reversed order of packets. The degree of reversed order of packets increases according to the difference of delay between the two TCP connections. Thus, in order to avoid this, handling of DSN in a TCP connection to be maintained is devised.

Specifically, the handling is performed as follows. It is to be noted that although a case is described herein in which between the two TCP connections, one connection via LTE is closed and the other connection via Wi-Fi is maintained, another case may be implemented similarly.

First, a transmission device (for instance, wireless terminal 10 or the server 20) compares the delays in the TCP connections between LTE and Wi-Fi. Here, each delay corresponds to half the above-described RTT. Note that instead of comparing delays, RTTs or throughputs may be compared.

Let DL be the delay of a TCP connection via LTE and D_{W} be the delay of a TCP connection via Wi-Fi. Here, when D_{L}<D_{W}, in the TCP connection via Wi-Fi, data subsequent to the data during transmission in the TCP connection via LTE is transmitted. Specifically, for instance, let DSN be the DSN of a start data packet to be transmitted in the TCP connection via Wi-Fi, then DSN may be obtained as follows: DSN=DSN_{L}+(D_{W}−D_{L})×S_{L}, where DSN_{L} is the DSN of the data packet transmitted last in the TCP connection via LTE, and S_{L} is the throughput (which may be measured in the same manner as in S105 of FIG. 1) of the TCP connection via LTE. In this manner, it is possible to avoid or suppress reversed order of packets, which is caused by long delay on the Wi-Fi side. Note that although the data packets up to DSN_{W}−1 have not been transmitted in the TCP connection via Wi-Fi, those packets are transmitted in the TCP connection via LTE.

On the other hand, when D_{L} D_{W}, in the TCP connection via Wi-Fi, the data during transmission in the TCP connection via LTE is transmitted redundantly. Specifically, for instance, the above-described DSN may be obtained as follows: DSN=DSN_{L}−(D_{L}−D_{W})×S_{W}, where S_{W} is the throughput of the TCP connection via Wi-Fi. In this manner, it is possible to avoid or suppress reversed order of packets, which is caused by long delay on the LTE side.

[Network Configuration of Communication System of Each Embodiment]

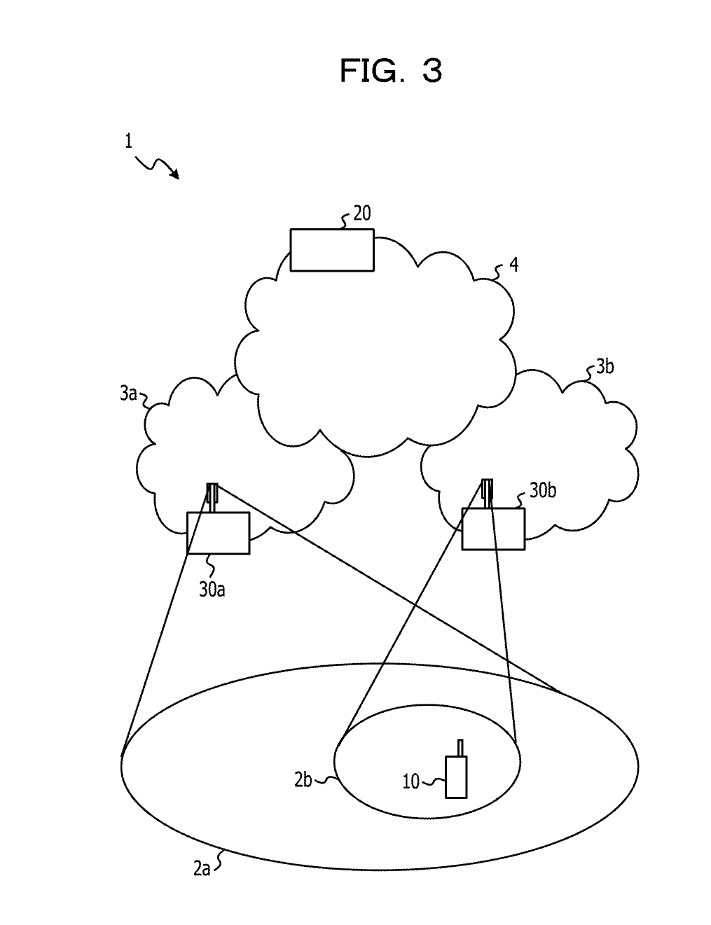

Next, the network configuration of a communication system 1 in each embodiment and each modification will be described based on FIG. 3. As illustrated in FIG. 3, the communication system 1 includes the wireless terminal 10, the server 20, the first wireless base station 30a, and the second wireless base station 30b. It is to be noted that hereinafter the first wireless base station 30a and the second wireless base station 30b may be collectively referred to as the wireless base station 30.

The wireless terminal 10 is capable of utilizing multiple wireless communication systems (wireless communication methods). As already described, the multiple wireless communication systems given in the present application are assumed to have different IP addresses assigned to the wireless terminal 10.

Here, as an example, a case is presented in which the wireless terminal 10 is capable of utilizing a first wireless communication system and a second wireless communication system. However, it goes without stating that the present disclosure is applicable to the case in which the wireless terminal 10 is capable of utilizing three of more wireless communication systems.

Here, the first wireless communication system (the first wireless communication method) includes, for instance, LTE (including such as LTE-A), and a cellular wireless communication system such as Wideband Code Division Multiple Access (W-CDMA). Also, the second wireless communication system (the second wireless communication method) includes, for instance, a wireless LAN such as Wi-Fi and WiMAX (registered trademark), a wireless communication system based on Bluetooth (registered trademark), GPS, Zigbee (registered trademark), Global System for Mobile communications (GSM, registered trademark), Universal Mobile Telecommunications System (UMTS). However, it is to be noted that as long as the above-mentioned assumption regarding the IP address is satisfied, as a combination of the first wireless communication system and the second wireless communication system, other pairs of systems different from what has been presented herein are applicable.

The wireless terminal 10 may be a mobile phone, a smart phone, PDA (Personal Digital Assistant), a personal computer, or various devices and equipment (such as sensor unit) having a wireless communication function. When a relay station is used to relay wireless communication between the wireless base station 30 and the wireless terminal 10, the relay station (transmission and reception to and from the wireless base station 30 and relevant control) may also be included in the wireless terminal 10 of the present application.

The server 20 is a device that serves as a communication partner (communication destination) of the wireless terminal 10 in an MPTCP connection. As described above, the server 20 in the present application may be a relay device, for instance. It goes without stating that although the server 20 is connected to Internet 4 in FIG. 3, the server 20 may be connected to a network other than the Internet 4.

Each of two wireless base stations 30 provides a wireless access network and is connected to a wireless core network. As an example, a case is described herein in which the first wireless base station 30a described above is a wireless base station 30 based on LTE and the second wireless base station 30b is a wireless access point based on Wi-Fi. However, as described above, a combination other than this is applicable.

For instance, the first wireless base station (for instance, a wireless base station of LTE) 30a provides a first wireless access network (for instance, an LTE (access) network) 2a, and is connected to a first core network (for instance, an LTE core network) 3a. On the other hand, the second wireless base station (for instance, a wireless access point of Wi-Fi) 30b provides a second wireless access network (for instance, a Wi-Fi (access) network) 2b, and is connected to a second core network (for instance, a public Wi-Fi wireless network) 3b. It is to be noted that although the first wireless access network 2a includes the second wireless access network 2b in FIG. 3, this is only an example. It goes without stating that although the first wireless base station 30a and the second wireless base station 30b are each illustrated as a single station in FIG. 1, multiple stations are applicable.

The wireless terminal 10 described above is capable of performing communication with the first wireless base station 30a via the first wireless access network 2a as well as with the second wireless base station 30b via the second wireless access network 2b. On the other hand, the first core network 3a and the second core network 3b are connected to the Internet 4 via a relay device which is not illustrated. Therefore, the wireless terminal 10 is capable of communicating with the server 20 via each of the networks.

The wireless base station 30 may separate digital signal processing and control functions from a wireless communication function for communication with the wireless terminal 10, and may provide another device for the separated functions. In this case, a device having a wireless communication function is called a remote radio head (RRH) and a device having digital signal processing and control functions is called a base band unit (BBU). RRH is installed that jetties from BBU, and a cable such as an optical fiber may connect between them. The wireless base station 30 may be a small-sized wireless base station (including a micro wireless base station, a femto wireless base station), a macro wireless base station, a pico wireless base station or other wireless base station with various scales. When a relay station is used to relay wireless communication between the wireless base station 30 and the wireless terminal 10, the relay station (transmission and reception to and from the wireless terminal 10 and relevant control) may also be included in the wireless base station 30 of the present application.

Note that a specific aspect of distribution and integration of the components of the wireless base station 30 and the wireless terminal 10 is not limited to the aspect of the first embodiment, and all or part of the components may be functionally or physically distributed or integrated in any unit and configured according to various loads and use conditions. For instance, a memory may be connected via a network or a cable as an external device of the wireless base station 30, the wireless terminal 10.

[Functional Configuration of Each Device in Communication System in Each Embodiment]

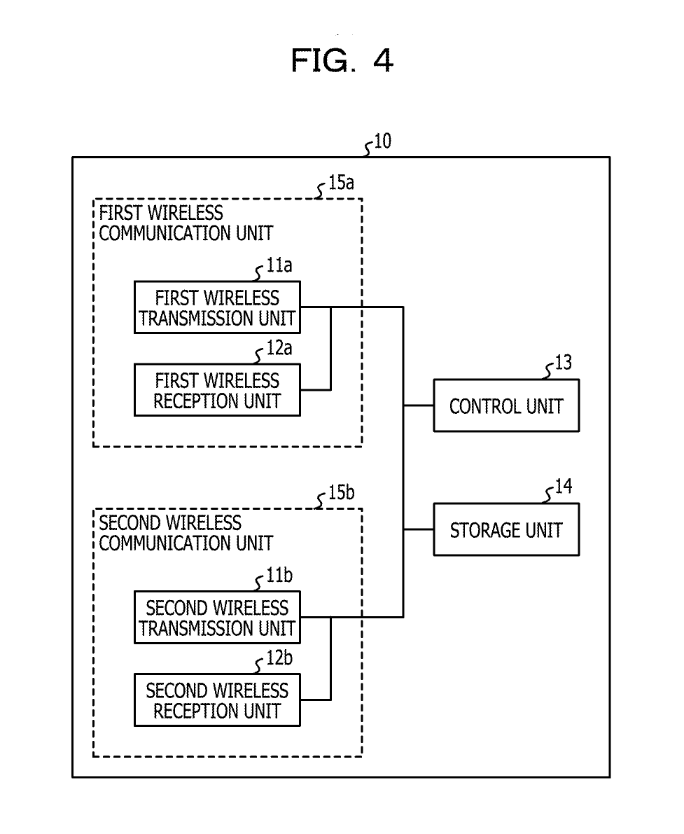

Next, the functional configuration of each device in the communication system of each embodiment and each modification based on FIGS. 4 to 6 will be described.

FIG. 4 is a functional block diagram illustrating the configuration of the wireless terminal 10. As illustrated in FIG. 4, the wireless terminal 10 includes a first wireless transmission unit 11a, a second wireless transmission unit 11b, a first wireless reception unit 12a, a second wireless reception unit 12b, a control unit 13, and a storage unit 14. These components are connected to allow signals and data to be inputted and outputted unidirectionally or bidirectionally. The first wireless transmission unit 11a and the first wireless reception unit 12a may be collectively referred to as a first wireless communication unit 15a. Also, the second wireless transmission unit 11b and the second wireless reception unit 12b may be collectively referred to as a second wireless communication unit 15b.

The first wireless transmission unit 11a transmits a wireless signal based on the first wireless communication system (for instance, an LTE) via the first wireless access network (for instance, an LTE wireless network) 2a.

Specific examples of a wireless signal transmitted by the first wireless transmission unit 11a include each signal (each information) transmitted by the wireless terminal 10 via the first wireless access network 2a based on the first wireless communication system in FIGS. 1 and 2. Examples of such signals (information) include the information transmitted by the wireless terminal 10 through a TCP connection via an LTE wireless network. The signals transmitted by the first wireless transmission unit 11a are not limited to these and include all signals transmitted by the wireless terminal 10 via the first wireless access network 2a based on the first wireless communication system in each embodiment and modification described above.

The first wireless reception unit 12a receives a wireless signal based on the first wireless communication system (for instance, an LTE) via the first wireless access network (for instance, an LTE wireless network) 2a.

Specific examples of a wireless signal received by the first wireless reception unit 12a include each signal (each information) received by the wireless terminal 10 via the first wireless access network 2a based on the first wireless communication system in FIGS. 1 and 2. Examples of such signals (information) include the information received by the wireless terminal 10 through a TCP connection via an LTE wireless network. The signals received by the first wireless reception unit 12a are not limited to these and include all signals received by the wireless terminal 10 via the first wireless access network 2a based on the first wireless communication system in each embodiment and modification described above.

The second wireless transmission unit 11b transmits a wireless signal based on the second wireless communication system (for instance, a Wi-Fi) via the second wireless access network (for instance, a Wi-Fi wireless network) 2b.

Specific examples of a wireless signal transmitted by the second wireless transmission unit 11b include each signal (each information) transmitted by the wireless terminal 10 via the second wireless access network 2b based on the second wireless communication system in FIGS. 1 and 2. Examples of such signals (information) include the information transmitted by the wireless terminal 10 through a TCP connection via a Wi-Fi wireless network. The signals transmitted by the second wireless transmission unit 11b are not limited to these and include all signals transmitted by the wireless terminal 10 via the second wireless access network 2b based on the second wireless communication system in each embodiment and modification described above.

The second wireless reception unit 12b receives a wireless signal based on the second wireless communication system (for instance, a Wi-Fi) via the second wireless access network (for instance, a Wi-Fi wireless network) 2b.

Specific examples of a wireless signal received by the second wireless reception unit 12b include each signal (each information) received by the wireless terminal 10 via the second wireless access network 2b based on the second wireless communication system in FIGS. 1 and 2. Examples of such signals (information) include the information received by the wireless terminal 10 through a TCP connection via a Wi-Fi wireless network. The signals received by the second wireless reception unit 12b are not limited to these and include all signals received by the wireless terminal 10 via the second wireless access network 2b based on the second wireless communication system in each embodiment and modification described above.

The control unit 13 generates a signal to be transmitted by the wireless terminal 10 and outputs the signal to the first wireless transmission unit 11a or the second wireless transmission unit. In addition, the control unit 13 receives an input of a signal received by the first wireless reception unit 12a or the second wireless reception unit, and performs various types of processing. In addition to these, the control unit 13 performs various types of control related to various transmission signals transmitted by the first wireless transmission unit 11a and the second wireless transmission unit 11b, and to various reception signals received by the first wireless reception unit 12a and the second wireless reception unit 12b.

Specific examples of processing controlled by the control unit 13 include each processing performed by the wireless terminal 10 in FIGS. 1 and 2. The processing performed by the control unit 13 is not limited to these and includes all processing performed by the wireless terminal 10 in each embodiment and modification described above.

The storage unit 14 stores all the information stored by the wireless terminal 10.

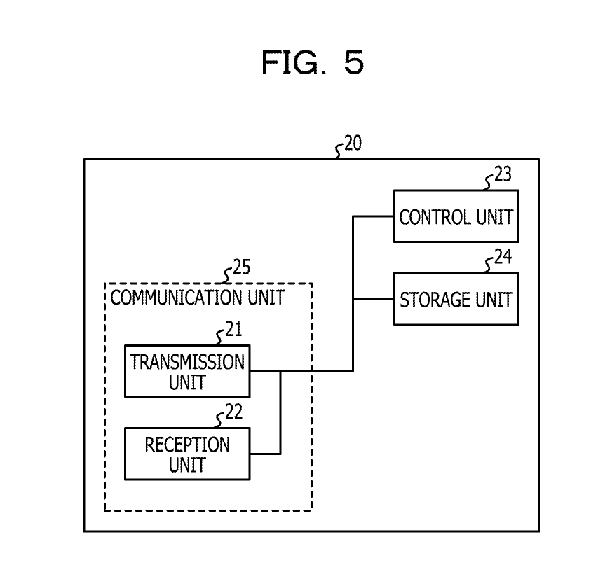

FIG. 5 is a functional block diagram illustrating the configuration of the server 20. As illustrated in FIG. 5, the server 20 includes a transmission unit 21, a reception unit 22, a control unit 23, and a storage unit 24. These components are connected to allow signals and data to be inputted and outputted unidirectionally or bidirectionally. The transmission unit 21 and the reception unit 22 may be collectively referred to as a communication unit 25.

The transmission unit 21 transmits a signal via various networks.

Specific examples of a signal transmitted by the transmission unit 21 include each signal (each information) transmitted by the server 20 in FIGS. 1 and 2. Examples of such signals (information) include the information transmitted by the server 20 through a TCP connection via an LTE wireless network or a TCP connection via a Wi-Fi wireless network. The signals transmitted by the transmission unit 21 are not limited to these and include all signals transmitted by the server 20 in each embodiment and modification described above.

The reception unit 22 receives a signal via various networks of the Internet 4.

Specific examples of a signal received by the reception unit 22 include each signal (each information) received by the server 20 in FIGS. 1 and 2. Examples of such signals (information) include the information received by the server 20 through a TCP connection via an LTE wireless network or a TCP connection via a Wi-Fi wireless network. The signals received by the reception unit 22 are not limited to these and include all signals received by the server 20 in each embodiment and modification described above.

The control unit 23 generates a signal to be transmitted by the server 20 and outputs the signal to the transmission unit 21. In addition, the control unit 23 receives an input of a signal received by the reception unit 22, and performs various types of processing. In addition to these, the control unit 23 performs various types of control related to various transmission signals transmitted by the transmission unit 21 and various reception signals received by the reception unit 22.

Specific examples of processing controlled by the control unit 23 include each processing performed by the server 20 in FIGS. 1 and 2. The processing performed by the control unit 23 is not limited to these and includes all processing performed by the server 20 in each embodiment and modification described above.

The storage unit 24 stores all the information stored by the server 20.

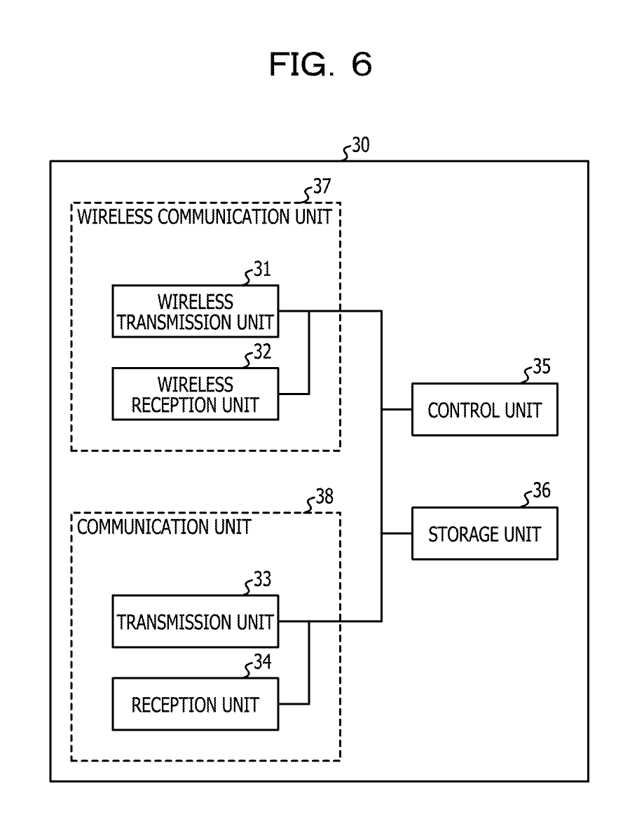

FIG. 6 is a functional block diagram illustrating the configuration of the wireless base station 30. As illustrated in FIG. 6, the wireless base station 30 includes a wireless transmission unit 31, a wireless reception unit 32, a transmission unit 33, a reception unit 34, a control unit 35, and a storage unit 36. These components are connected to allow signals and data to be inputted and outputted unidirectionally or bidirectionally. The wireless transmission unit 31 and the wireless reception unit 32 may be collectively referred to as a wireless communication unit 37. Also, the transmission unit 33 and the reception unit 34 may be collectively referred to as a communication unit 38.

The wireless transmission unit 31 transmits a wireless signal via a predetermined wireless communication network based on a predetermined wireless communication system. The wireless reception unit 32 receives a wireless signal via a predetermined wireless communication network based on a predetermined wireless communication system. The transmission unit 33 transmits a signal via a predetermined communication network. Also, the reception unit 34 receives a signal via a predetermined communication network. The control unit 35 performs various types of processing related to transmission signals and reception signals. The storage unit 36 stores all information stored by the wireless base station 30.

[Hardware Configuration of Each Device in Communication System in Each Embodiment]

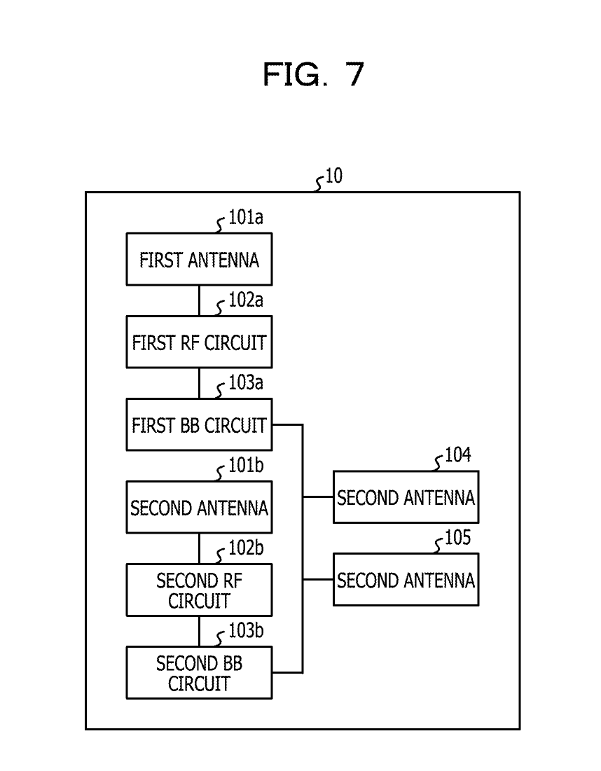

The hardware configuration of each device in the wireless communication system of each embodiment and each modification will be described based on FIGS. 7 to 9.

FIG. 7 is a diagram illustrating the hardware configuration of the wireless terminal 10. As illustrated in FIG. 7, the wireless terminal 10 has, for instance, a first antenna 101a, a second antenna 101b, a first radio frequency (RF) circuit 102a, a second RF circuit 102b, a first baseband (BB) circuit 103a, a second BB circuit 103b, a central processing unit (CPU) 104, and a memory 105 as the components of the hardware.

The first BB circuit 103a and the second BB circuit 103b are formed of, for instance, an application specific integrated circuit (ASIC), a digital signal processor (DSP), a large scale integration (LSI), and/or a field programmable gate array (FPGA). The memory 105 includes, for instance, at least one of a random access memory (RAM), a read only memory (ROM), and a flash memory, and stores programs, control information, data and others.

The correspondence between the functional configuration of the wireless terminal 10 illustrated in FIG. 4 and the hardware configuration of the wireless terminal 10 illustrated in FIG. 7 will be described. The first wireless transmission unit 11a and the first wireless reception unit 12a (or the first wireless communication unit 15a) are achieved by the first antenna 101a and the first RF circuit 102a, for instance. The second wireless transmission unit 11b and the second wireless reception unit 12b (or the second wireless communication unit 15b) are achieved by the second antenna 101b and the second RF circuit 102b, for instance. The control unit 13 is achieved by the first BB circuit 103a, the second BB circuit 103b, the CPU 104, and the memory 105, for instance. The storage unit 14 is achieved by the memory 105, for instance.

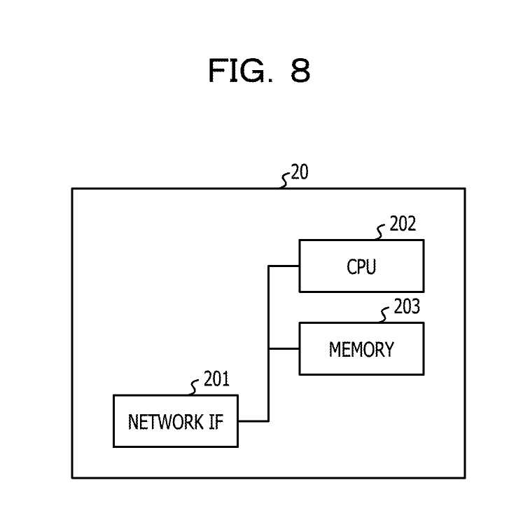

FIG. 8 is a diagram illustrating the hardware configuration of the server 20. As illustrated in FIG. 8, the server 20 has, for instance, a network interface (IF) 201, a CPU 202, and a memory 203 as the components of the hardware.

The network IF 201 is an interface module for connecting to a network such as Ethernet (registered trademark), for instance.

The correspondence between the functional configuration of the server 20 illustrated in FIG. 5 and the hardware configuration of the server 20 illustrated in FIG. 8 will be described. The transmission unit 21 and the reception unit 22 (or the communication unit 25) are achieved by the network IF 201, for instance. The control unit 23 is achieved by the CPU 202 and the memory 203, for instance. The storage unit 24 is achieved by the memory 203, for instance.

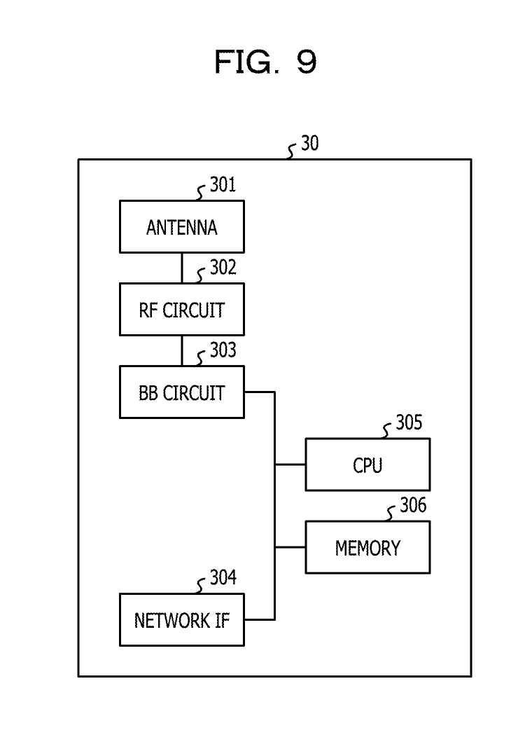

FIG. 9 is a diagram illustrating the hardware configuration of the wireless base station 30. As illustrated in FIG. 9, the wireless base station 30 has, for instance, an antenna 301, an RF circuit 302, a BB circuit 303, a network IF 304, a CPU 305, and a memory 306 as the components of the hardware.

The correspondence between the functional configuration of the wireless base station 30 illustrated in FIG. 6 and the hardware configuration of the wireless base station 30 illustrated in FIG. 9 will be described. The wireless transmission unit 31 and the wireless reception unit 32 (or the wireless communication unit 37) are achieved by the antenna 301 and the RF circuit 302, for instance. The transmission unit 33 and the reception unit 34 (or the communication unit 38) are achieved by the network IF 304, for instance. The control unit 35 is achieved by the BB circuit 303, the CPU 305, and the memory 306, for instance. The storage unit 36 is achieved by the memory 306, for instance.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication device comprising:
a memory; and
a processor coupled to the memory and configured to:
perform a data communication in a connection established between the communication device and another communication device based on a first communication protocol, a specified parameter in the first communication protocol being set to a specified value when the connection is started, the specified parameter influencing a data transfer rate of the started connection in a first layer of the first communication protocol, the specified parameter being gradually updated so that the data transfer rate is increased as the communication is performed in the started connection, and
when a first connection based on the first communication protocol has been established between the communication device and another specified communication device via a first wireless communication network based on a first radio access technology and when a second connection based on the first communication protocol is started between the communication device and the other specified communication device via a second wireless communication network based on a second radio access technology, start the second connection without closing the first connection, wherein
a determination whether to close the first connection is made based on an index value relating a second data transfer rate of the second connection in the first layer of the first communication protocol.

2. The communication device according to claim 1, wherein
the processor is configured to aggregate the first connection and the second connection into a third connection in a second layer of a second communication protocol, a plurality of connections established between the same pair of communication devices in the first layer of the first communication protocol being aggregated into a connection in the second communication protocol.

3. The communication device according to claim 1, wherein
in the determination, which of the first connection and the second connection is determined to close based on comparing the index value with another index value relating a first data transfer rate of the first connection in the first layer of the first communication protocol.

4. The communication device according to claim 1, wherein
the determination is made when a transferring from a first phase to a second phase is detected in the second connection, in the second phase the specified parameter being gradually updated so that the data transfer rate is increased more slowly than in the first phase.

5. The communication device according to claim 1, wherein
the processor is configured to make the determination.

6. The communication device according to claim 1, wherein
a first internet protocol (IP) address is different from a second IP address, the first IP address being allocated to the communication device by the first wireless communication network, the second IP address being allocated to the communication device by the second wireless communication network.

7. The communication device according to claim 1, wherein
the processor is configure to redundantly transmit or receive packets including the same data in the first connection and the second connection.

8. The communication device according to claim 1, wherein
the first communication protocol is transmission control protocol (TCP), and
the specified parameter is a window size of TCP.

9. The communication device according to claim 8, wherein
the first communication protocol is multipath transmission control protocol (MPTCP).

10. The communication device according to claim 8, wherein
the index value is a throughput in TCP.

11. A wireless communication device comprising:
a first wireless communication interface configured to perform a wireless communication via a first wireless communication network based on a first radio access technology;
a second wireless communication interface configured to perform a wireless communication via a second wireless communication network based on a second radio access technology; and
a processor configured to:
perform a data communication in a connection established between the communication device and another communication device based on a first communication protocol, a specified parameter in the first communication protocol being set to a specified value when the connection is started, the specified parameter influencing a data transfer rate of the started connection in a first layer of the first communication protocol, the specified parameter being gradually updated so that the data transfer rate is increased as the communication is performed in the started connection, and
when a first connection based on the first communication protocol has been established between the communication device and another specified communication device via the first wireless communication network based on the first radio access technology and when a second connection based on the first communication protocol is started between the communication device and the other specified communication device via the second wireless communication network based on the second radio access technology, start the second connection without closing the first connection, wherein
a determination whether to close the first connection is made based on an index value relating a second data transfer rate of the second connection in the first layer of the first communication protocol.

12. A communication method comprising:
performing a data communication in a connection established between the communication device and another communication device based on a first communication protocol, a specified parameter in the first communication protocol being set to a specified value when the connection is started, the specified parameter influencing a data transfer rate of the started connection in a first layer of the first communication protocol, the specified parameter being gradually updated so that the data transfer rate is increased as the communication is performed in the started connection, and
when a first connection based on the first communication protocol has been established between the communication device and another specified communication device via a first wireless communication network based on a first radio access technology and when a second connection based on the first communication protocol is started between the communication device and the other specified communication device via a second wireless communication network based on a second radio access technology, starting the second connection without closing the first connection, wherein
a determination whether to close the first connection is made based on an index value relating a second data transfer rate of the second connection in the first layer of the first communication protocol.
